(19) United States
(12) Patent Application Publication
(10) Pub. No.: US 2004/0033810 A1
(43) Pub. Date: Feb. 19, 2004

(54) Audio visual communications system

(76) Inventors: Patricia Nichole Griffin, Park Forest, IL (US); Sinatra Frank Griffin JR., Park Forest, IL (US)

Correspondence Address: Sinatra F. Griffin,, 9 Mantua CT, Park Forest, IL, 60466, US

(21) Appl. No.: 10/637,874

(22) Filed: Aug. 8, 2003

Related U.S. Application Data
(60) Provisional application No. 60/402,658, filed on Aug. 12, 2002.

(51) Int. Cl. H04B 7/185

(52) U.S. Cl. 455/550.1; 455/414.1; 455/12.1; 455/552.1

(57) ABSTRACT

A system transforming standard equipment into rich media communications devices. The Audio Visual Communications System support the simple truth of business, personal and family integration and assists in providing balance between these areas.

### CROSS-REFERENCE TO RELATED APPLICATIONS

The Audio Visual Communications System was filed as a provisional patent application on Aug. 12, 2002; application No. 60/402,658; confirmation number 8366.

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

(a) Field of the Invention

The Audio Visual Communications System relates generally to a system and method for providing multifunctional media stations or devices for private and business use. The present invention combines broadcast television and radio with portable, mobile and stationary devices via satellite data transmissions also allowing for visual record and transmission of personal and business messages or greetings. It takes a typical apparatus and super sizes its use, transforming it into a powerful communications unit.

(b) Background of the Invention

The workplace is changing. Employees are determined to find proper balance between business and personal life and downtime is as essential as uptime. The present invention accommodates both.

When, where and how work is done is no longer based on a traditional mindset. The present invention allows for better control of personal and business life which undoubtedly creates increased production and loyalty.

### BRIEF SUMMARY OF THE INVENTION

The present invention allows for an assortment of rich media communications within standard devices. Such variations range from portable computers with radio and television capabilities, mobile disc players with satellite access and wireless phones with MPEG (Moving. Picture Experts Group) Audio Layer-3 ability.

Standard devices using Geosynchronous and Communications satellites are limited in function. For example: satellite television is primarily watched in residences on TV sets; only car and portable radios use satellite radio and; rural stationed CPU's (central processing units) have access to satellite Internet.

Further, visual recording was left only to video camera-recorders and MP3 player's primary function is the transfer of MP3 files.

The Audio Visual Communications System realigns existing operating systems into new methods, allowing devices to become multi-functional units that can be used for business, personal and family purposes.

With these new methods, the present invention also allows for space efficiency.

### BRIEF DESCRIPTION OF THE SEVREAL VIEWS OF THE DRAWING

FIG. 1 An example of an apparatus (portable computer) with radio and TV capabilities.

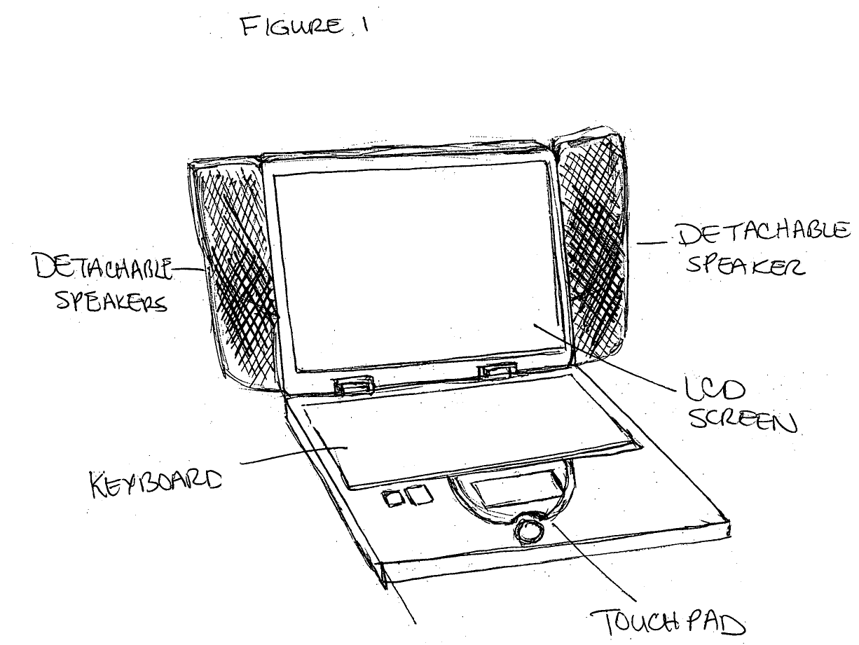

FIG. 2 An example of an apparatus (disc player) with satellite and visual recording capabilities.

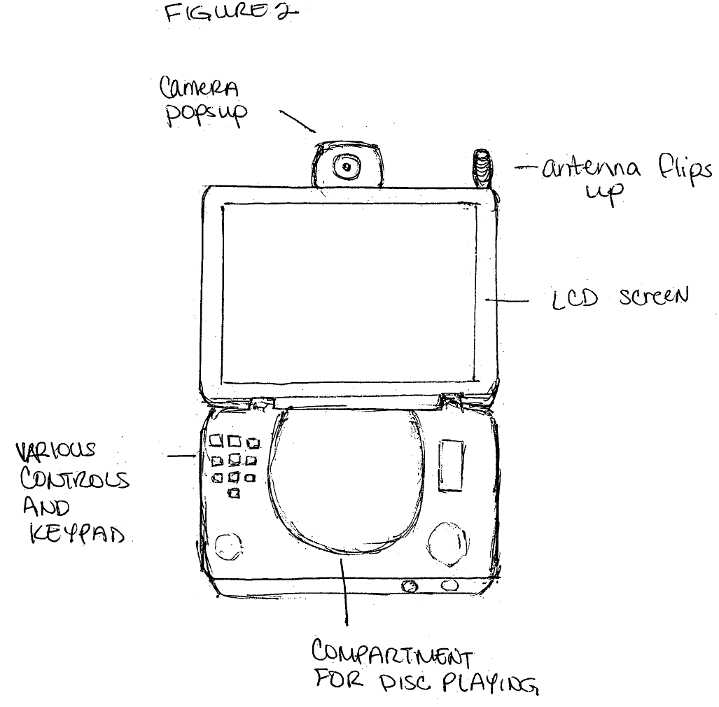

FIG. 3 An example of the Audio Visual Communications device allowing specific individuals to play pre-recorded greetings or messages and allowing for the playing of discs, such as Compact Discs and DVDs.

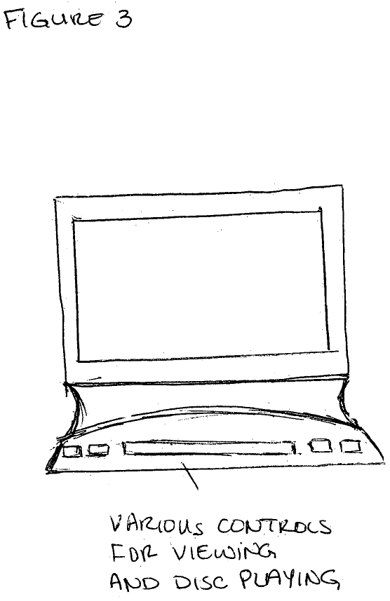

FIG. 4 An example of an apparatus (wireless phone) with MP3 playing ability. The drawings are only examples and are not intended to limit the present invention described.

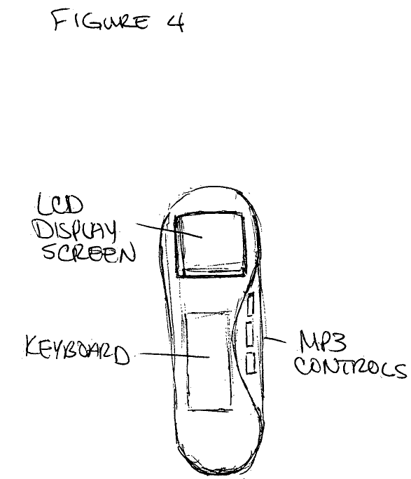

### DETAILED DESCRIPTION OF THE INVENTION

Apparatus (portable computer) with radio, television and Internet capabilities.

The microprocessor is the brain of the apparatus and manages all the computer's functions as instructed by the operating system.

The operating system is a set of pre-programmed instructions.

Memory includes both RAM (random access) and ROM (read-only) memory—RAM stores data files and application software while the apparatus is in power. ROM chips contain the BIOS (basic input/output system).

The apparatus has an internal hard disk drive which stores the operating systems, data files and application programs. Removable disk storage system (floppy disks, compact discs, DVDs and zip disks) are also options.

Input/output ports and PC cards are also incorporated and the apparatus is powered by AC power and rechargeable (lithium, nickel-metal hybrid or nickel-cadmium) batteries the use of batteries allowing for mobility. Other batteries (in addition to the main battery) and CMOS (complementary metal oxide semiconductor) RAM run the clock system.

The LCD (liquid crystal display) screen is used for word processing, presentations, reports, Internet, television broadcasting and other display needs.

Television programming is delivered by a wireless system (satellite) via radio signal. Broadcast stations transmit these radio waves to the surrounding area by way of a powerful antenna and the apparatus picks up the signal with a smaller antenna. The antenna may be external, internal or both.

Ground transmitters supplement the system, when satellite signals are blocked by buildings or other obstacles.

Programming is transmitted in the Ku frequency range, that is 12 GHz to 14 GHz.

Channel options can be made through registration and subscription filled out by the user at a designated web site. The subscription can also be designed into an application program within the operating system—allowing the user to fill out the appropriate information linked to a designated server. Another option is to have the user pre-pay for the service—costs added to overall price of the apparatus. Registration can be completed as the user powers the apparatus for the first time.

The satellite-based Digital Audio Radio Service (DARS) uses an allocated spectrum in the S band (2.3 GHz) which transmits signals from designated satellite to a radio receiver within the apparatus. The receiver is programmed to receive and unscramble the digital data signal.

An option to accommodate both radio and television satellite signals is to have one receiver on one end of the apparatus and one receiver on the other end. One receiver programmed to pick up the Ku frequency range and the other receiver coded to pick up S band signals.

Another option would be to design one receiver programmed to recognize both S and Ku frequencies. When a signal is picked up, the receiver is programmed—acting as a traffic cop—to transmit the signal to the appropriate location within the apparatus' operating system. For example, for satellite television: at the broadcast center, a MPEG-2 encoder converts programming to MPEG-2 video of the correct size and format. Irrelevant data is eliminated. After a signal is encrypted and compressed, it's sent to one of the broadcast center's satellites where it is amplified and beamed back to Earth, where the apparatus can pick it up. The receiver deciphers the frequency as in the Ku (or 12 GHz to 14 GHz) de-scrambles the encrypted signal with a decoder chip. The DVI (Digital Video Interface), or similar thereof, keeps the data in digital form eliminating signal loss and the signal is taken from the graphics adapter by way of TDMS (Transition Minimized Differential Signaling) and spread over the available bandwidth where the user views the broadcast on the LCD screen of the apparatus.

If the receiver picks up and deciphers a 2.3 GHz signal (S band), the transmission is unscrambled and sent to the apparatus' digital sound card where the sound is processed and heard through the speakers.

The apparatus will have two-way data communications (two modems) allowing for upload and download for Internet ability.

Apparatus (disc player) with satellite and visual recording capabilities.

MPEG-2 encoded movies are decoded and turned into a standard composite video signal. The audio stream is sent to a Dolby decoder, amplified, and sent to the speakers.

The apparatus finds and read data stored on the disk. A drive motor spins the disc and a tracking mechanism moves the laser at micron resolutions. Data is formed into understandable blocks and is transmitted to either the digital-to-analog converter (for audio or video data) or to another component in digital format (for digital video or data).

A camera is installed to the apparatus for visual recording where the user can make personal and business messages or greetings.

The camera receives visual information and interprets it as an electronic video signal. The signal (analog) information is translated to bytes of data, by way of the analog-to-digital converter, and records the picture and sound as 1s and 0s.

Information is recorded digitally and can use the Digital Video cassette, Digital 8 format or similar thereof.

Once the user is complete with their greeting of message, the data can be sent to its designee via Internet and e-mail; thus, a modem is added to the apparatus.

One option is that an e-mail message is sent to the designee indicating that the user has a visual message for them. A hyperlink to the Uniform Resource Location (URL) is readily accessible where the designee views the message.

Another option is to have a device containing the necessary operating system, memory and central processing unit to download visual data from a designated web site. The user can buy the Audio Visual Communications device, set up an account—as with digital picture frames—and pass it on to family and loved ones.

) A modem, display screen and controls are also a part of the device.

The end user (with the device) only needs to plug the device into a power outlet and phone line to view the message or greeting.

This Audio Visual Communications device works as a multifunctional unit allowing for DVD playing.

Apparatus (wireless phone) with MP3 playing abilities.

MP3 playing capabilities are incorporated in the apparatus where it pulls the song from memory, decompress the encoding, run the decompressed data through a digital-to-analog converter and amplify the signal.

Main components of the apparatus include: power supply; amplifier, audio port, playback controls, LCD display, DSP (digital signal processor), microprocessor, memory, data port, circuit board, antenna, keyboard, microphone, speaker and battery.

The data is transferred to the apparatus via USB (Universal Serial Bus), or parallel port, and MP3 files are saved in the device's memory.

Headphones and ear plugs are made available.

What is claimed is:

1. A portable, mobile apparatus or similar thereof, consisting of personal, business computing, television, radio and internet capability:
(a) The system or method allows for satellite broadcasting, radio, communication and internet ability within one device or unit.

2. A receiver designed to pick up and decipher specific, multi radio signals, programmed to channel these signals, based on its frequency, to the appropriate location within the apparatus' operating system, for multifunctional use.

3. An apparatus consisting of disc playing and visual recording capability:
(a) This apparatus may be portable, mobile and include a modem, or similar thereof, allowing for electronic mail, internet and playback of visual communication.

4. A system or method allowing for portable, mobile, wireless communication and recorded, prerecorded music playback capability within one device or unit.
